(19) United States
(12) Patent Application Publication
(10) Pub. No.: US 2025/0292051 A1
(43) Pub. Date: Sep. 18, 2025

(54) CONSUMABLE MANAGEMENT SYSTEM AND CONSUMABLE MANAGEMENT APPARATUS

(71) Applicant: BROTHER KOGYO KABUSHIKI KAISHA, Nagoya (JP)

(72) Inventors: Koichi TSUGIMURA, Nagoya (JP); Taichiro KIMOTO, Nagoya (JP); Yutaka TAKIJIRI, Nagoya (JP)

(21) Appl. No.: 19/083,035

(22) Filed: Mar. 18, 2025

(30) Foreign Application Priority Data
Mar. 18, 2024 (JP) 2024-042602

(51) Int. Cl. G06K 15/00; G06Q 10/083

(52) U.S. Cl. CPC G06K 15/4075; G06K 15/002; G06Q 10/083

(57) ABSTRACT

A consumable management system comprises a consuming device configured to consume a consumable and a controller. The controller is configured to receive a request to switch from a first contract for delivering the consumable to a second contract. The controller is further configured to transmit a notification to a user in response to particular information in first contract information on the first contract being different from particular information in second contract information on the second contract.

### REFERENCE TO RELATED APPLICATIONS

This application claims priority from Japanese Patent Application No. 2024-042602 filed on Mar. 18, 2024. The entire content of the priority application is incorporated herein by reference.

### BACKGROUND ART

The present disclosure relates to a consumable management system and a consumable management apparatus that allow switching of various contracts for consuming devices configured to consume consumables that need to be replaced or refilled.

For consumables that need to be replaced or refilled, there are known services for delivering the consumables in accordance with various contracts for the devices (hereafter, referred to as consuming devices) that consume the consumables.

Conventionally, there is known technology in which a degree of consumption of consumables and information on the consumables are obtained from the consuming device (e.g., a recording device). When the degree of consumption of consumables exceeds a particular degree, and information on the contract (hereafter, referred to as contract information) and information on the consumables satisfy a particular condition, a request for ordering such consumables is transmitted from the consuming device to an ordering device to request for the consumables, and then, the ordered consumables are delivered to the consuming device.

In such a case, when the number of days remaining until the current contract expires is less than a particular number of days, an order request based on information on the next (i.e., updated) contract may be transmitted.

### SUMMARY

Depending on whether a contract is switched (for example, between the current contract and the next contract), there may be differences in the services, such as different conditions for the delivery of consumables. In such a case, it is preferable to appropriately inform the user of such differences in the services.

Aspects of the present disclosure provide a technique for appropriately informing the user when the conditions of contracts are switched.

A consumable management system includes a consuming device configured to consume a consumable and a controller. The controller is configured to receive a request to switch from a first contract to a second contract different from the first contract, the first contract being a contract for delivering the consumable of the consuming device, and transmit a notification to a user of the consuming device in response to particular information in first contract information on the first contract being different from particular information in second contract information on the second contract.

A consumable management apparatus is configured to manage a consuming device configured to consume a consumable. The consumable management apparatus comprising a controller. The controller is configured to receive a request to switch from a first contract to a second contract different from the first contract, the first contract being a contract for delivering the consumable of the consuming device, and transmit a notification to a user of the consuming device in response to particular information in first contract information on the first contract being different from particular information in second contract information on the second contract.

### BRIEF DESCRIPTION OF DRAWINGS

FIG. 1 is a block diagram of a printing system.

FIG. 2 is a flowchart illustrating an ink delivery process performed by a server included in the printing system shown in FIG. 1.

FIG. 3A is a flowchart illustrating a first ink delivery process included in the ink delivery process shown in FIG. 2.

FIG. 3B is a flowchart illustrating a second ink delivery process included in the ink delivery process shown in FIG. 2.

FIG. 4 is a flowchart illustrating a first contract switching process which is included in the ink delivery process shown in FIG. 2.

FIG. 5 is a flowchart illustrating a second contract switching process which is included in the ink delivery process shown in FIG. 2.

### DESCRIPTION

Hereafter, an embodiment according to aspects of the present disclosure will be described in detail with reference to the accompanying drawings.

### Configuration of Print System

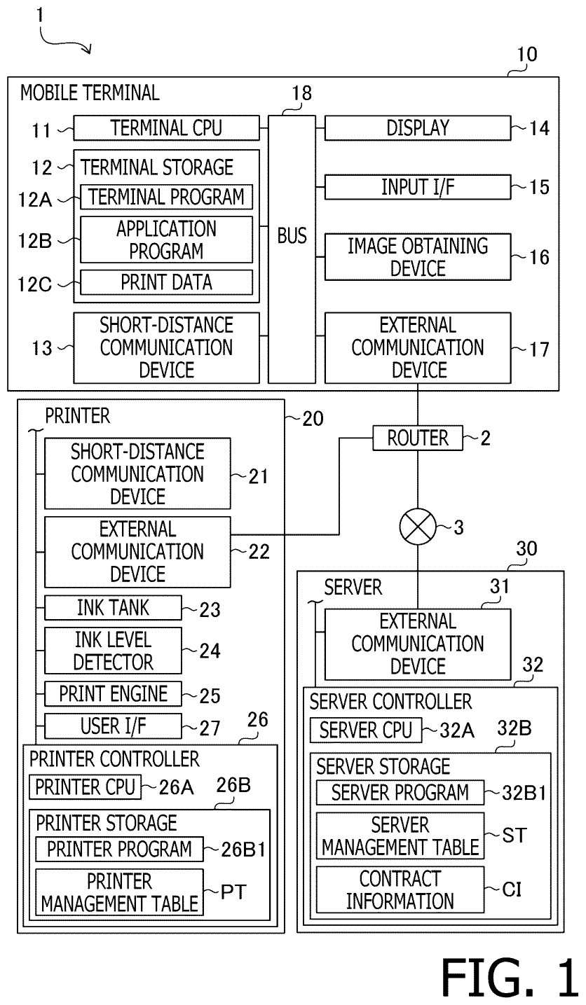

FIG. 1 is a block diagram of a print system 1 according to an embodiment of the present disclosure. It is noted that the print system 1 may be an example of a consumable management system according to aspects of the present disclosure. The print system 1 is used for a print service provided to a user who has concluded a contract, in which the user utilizes a printer 20. According to the present embodiment, the print service includes a service for delivering consumables for the printer 20, and includes two types of services, which are first and second print services. Further, a contract to be concluded for the user to enroll in the first print service will be referred to as a first print service contract, and a contract to be concluded for the user to enroll in the second print service will be referred to as a second print service contract.

The first print service is a service in which the user can enroll by concluding the first print service contract with a print service provider. In the first print service, the user purchases a desired number of printable faces (i.e., the user is charged for a purchased number of printable faces). In should be noted that a term “number of printable faces” will be used as a unit for counting the number of faces on which printing is to be performed. Since the user purchases the desired number of printable faces, the first print service is an on-demand service. In the following description, the number of printable face for the first print service will also be referred to as a printable face count.

It is noted that when printing is performed on one face of each sheet, one printable face corresponds to one printable sheet, while when printing is performed on both faces of each sheet, two printable faces correspond to one printable sheet.

It should also be noted that the number of printable faces also refers to the number of remaining faces on which printing can be performed. Therefore, each time printing is performed on one face of a sheet, the number of printable faces is reduced by one, while each time printing is performed on both faces, the number of printable faces is reduced by two.

It is noted that the printer 20 may be an example of a resource-consuming apparatus (e.g., an ink-consuming apparatus) according to aspects of the present disclosure.

The second print service is a service in which the user can enroll by concluding the second print service contract with the service provider. In the second print service contract, by paying a predetermined amount of money for a predetermined period of time (for example, one month), the user is allowed to perform printing on a predetermined number of faces. Therefore, the second print service is a so-called subscription service.

It is noted that the predetermined amount of money, the predetermined period of time, and the predetermined number of faces are defined by the second print service contract. In the following description, the predetermined number of faces for the second print service will also be referred to as a predetermined face count.

In the second print service, a term “printed face count” will also be used to indicate the number of faces on which printing has been performed. Each time printing is performed on one face of a sheet, the printed face count is increased by one, while each time printing is performed on both faces, the count is increased by two. By subtracting the printed face count from the predetermined number of faces, the remaining number of faces on which printing can be performed in accordance with the second print service contract can be obtained.

According to the present embodiment, the first print service is managed based on the number of printable faces which represents the remaining printable faces on which printing is allowed to be performed, and the initial value of the number of printable faces is the purchased number of printable faces. On the other hand, the second print service is managed based on the predetermined number of faces and the printed face count. The initial value of the predetermined number of faces is defined by the second print service contract. As will be described later, the user can purchase the number of printable faces also in the second print service. In such a case, the second print service is managed based on the predetermined number of faces, the printed face count and the number of printable faces.

It should be noted that the term “the printed face count” is used as a unit for counting the number of surfaces of the sheets on which the printing was performed. That is, the printed face count refers to the number of faces of the sheets on which the printing was performed. When printing was performed on one face of each sheet, the printed face count is the same as the number of physical sheets on which the printing was performed, while when printing was performed on both faces of the sheet, the printed face count is two for one physical sheets. Accordingly, when printing was performed on one side of each sheet, the printed face count has been increased by one, and when printing was performed on both faces of each sheet, the printed face count has been increased by two.

In the following explanations, a term “purchase” may be used when the number of printable faces is initially set or the number of printable faces is increased by purchasing (i.e., by paying money).

It is noted that “the number of printable faces” refers to the number of printable faces available, while “the purchased number of printable faces” refers to the number of printable faces purchased (i.e., to be added to the current number of printable faces).

If the term or the expiration date of the contract is specified by the contract in advance, the contract may be terminated based on the end of the term or the expiration date, regardless of whether the user has applied to cancel the user's membership.

Furthermore, the user is allowed to switch the print services in which the user currently enrolls to another print service. That is, the user can switch the first print service in which the user currently enrolls to the second print service, and vice versa. In such a case, the contract between the user and the print service provider should be switched in accordance with the switch of the print services.

A first contract according to aspects of the present disclosure may correspond to a contract for the print service before the contract is switched, while a second contract according to aspects of the present disclosure may correspond to a contract for the print service after the contract is switched.

In the present embodiment, the printer 20 is an inkjet printer, which is a commercially available product. In other words, the printer 20 is not necessarily a dedicated printer for the first or second print service according to the present embodiment, but a general-purpose printer can be employed as the printer 20. Therefore, while the user enrolls in the first or second print service, the printer 20 functions as the printer for the print service, and while the user does not enroll in the print service, the printer 20 functions as the general-purpose printer. It should be noted that, in the following description, when there is no need to distinguish between the first print service and the second print service, they will simply be referred to as the “print service(s).”

If the user wishes to print in excess of the current number of printable faces while the user enrolls in the first print service, or if the user wishes to print in excess of the predetermined number of faces while enrolling in the second print service, the user can purchase additional number of faces (i.e., additional printable faces), and keep using the printer 20 for the print service in which the user is currently enrolling. That is, by purchasing the desired number of printable faces (i.e., by paying to increase the number of printable faces), or by paying for the printable faces exceeding the predetermined number of faces, the user can continue to use the printer 20 for the print service in which the user is currently enrolling.

If an ink level (i.e., a remaining ink amount) in the printer 20 falls below a particular threshold (which may be an example of “particular information” according to aspects of the present disclosure) while the user is enrolling in the print service, the print service provider will deliver ink bottles or ink cartridges containing the ink to be filled in the printer 20 to the user free of charge. The user can continue printing up to the number of printable faces or up to the predetermined number of faces without running out of ink by refilling the printer 20 with the received ink bottle or replacing the ink cartridges.

Whether ink bottles or ink cartridges are delivered depends on whether the printer 20 is configured that, when it runs out of ink, an ink tank of the printer 20 is refilled with ink or the ink cartridges is replaced. In the present embodiment, it is assumed that the user has purchased the printer 20 that is configured to be refilled with ink when the printer 20 runs out of ink. Therefore, when the ink level of the printer 20 becomes low, the print service provider will deliver a bottle of ink to the user free of charge.

The threshold for the ink level of the printer 20 that is used as a reference to determine whether or not the ink bottles are to be delivered to the user differs between the first print service and the second print service. In the present embodiment, it is assumed that the threshold for the ink level in the first print service is α and the threshold in the second print service is β, where the threshold α is less than the threshold β.

The first print service is the on-demand service, and since the user only purchases the desired number of printable faces, if a situation arises where printing is not possible due to running out of ink, the number of printable faces will not be reduced.

On the other hand, the second print service is the subscription service, and the user is charged a fixed fee for a predetermined period of time, regardless of the printed face count. Therefore, even if the situation arises where printing is not possible due to running out of ink, the predetermined amount of money will be charged for the predetermined period of time.

It should be noted that a first threshold according to aspects of the present disclosure may correspond to a threshold for the ink level (i.e., the remaining amount of ink) in the print service before the switch (i.e., the currently enrolled print service), and the second threshold according to aspects of the present disclosure may correspond to the threshold for the ink level in the print service after the current contract is switched to another contract.

The print system 1 includes a mobile terminal 10, the printer 20, and a server 30. The mobile terminal 10 and the printer 20 are connected via a router 2 so that they can communicate with each other via a wired or wireless connection (for example, via a LAN). In addition, the mobile terminal 10 and the server 30 are connected via the router 2 and the Internet 3 so that they can communicate with each other. Furthermore, the printer 20 and the server 30 are connected via the router 2 and the Internet 3 so that they can communicate with each other.

The above-described network configuration is only one example. Alternatively, the server 30 may be located within the LAN. Further, the number of mobile terminals 10 and printers 20 connected to the server 30 may be more than one, and multiple mobile terminals 10 may be connected to a single printer 20, or a single mobile terminal 10 may select one of multiple printers 20 to perform printing.

### Configuration of Mobile Terminal

The mobile terminal 10 is configured to cause the printer 20 to print images on the sheet. The mobile terminal 10 is, for example, a smartphone. The mobile terminal 10 includes a terminal CPU 11, a terminal storage 12, a short distance communication device 13, a display 14, an input I/F (I/F being an abbreviation of Interface) 15, an image obtaining device 16, and an external communication device 17. The above elements are configured to communicate with each other via a bus 18.

The terminal storage 12 is configured by appropriately combining, for example, a RAM, a ROM, a flash memory, an HDD, and a buffer provided to the terminal CPU 11.

The terminal storage 12 stores a terminal program 12A, an application program (hereinafter referred to simply as “an application”) 12B, and print data 12C. The terminal program 12A is a program configured to control the mobile terminal 10 in an integrated manner, and to provide the application 12B with basic functions and services.

The terminal program 12A is, for example, Android OS (a registered trademark of Google LLC) or iOS (a registered trademark of Apple Inc.). Additionally, if the mobile terminal 10 is a PC (personal computer), the terminal program 12A is configured to operate on an OS such as Windows (a registered trademark of Microsoft Corporation).

An example of the application 12B is a web application program provided by the print service provider of the print service or a vendor of the printer 20, and when the user operates the mobile terminal 10 to use the application 12B, the application 12B transmits a request (i.e., the user's operation) to the server 30, receives data representing a web page generated by the server 30 in response to the request, and displays the web page on the display 14 based on the received data.

While the print service provider of the print service and the vendor of the printer 20 may be the same or different, in this embodiment, they are considered to be the same.

The application 12B is a program that executes various processes such as setting processes of the printer 20, print processes according to print commands using the printer 20, purchasing processes to send purchasing requests to the server 30 using the functions of the terminal program 12A and the like.

The terminal CPU 11 is configured to execute the terminal program 12A and/or the application 12B, and controls the mobile terminal 10, commands to the server 30, and the like. The terminal CPU 11 may be a single-core processor or a multi-core processor. The print data 12C is generated by converting the image to be printed into a format that can be interpreted by the printer 20. The terminal storage 12 also stores the number of printable faces and/or predetermined number faces to be referred to by the printer 20 in the print service.

In the following description, the mobile terminal 10, which executes the terminal program 12A and the application 12B with the terminal CPU 11, may be referred to simply by the name of the device. For example, a statement such as “the mobile terminal 10” may mean “the mobile terminal 10 that executes the terminal program 12A or the application 12B with the terminal CPU 11”. The same applies to the printer 20, which executes a printer program 26B1 with a printer CPU 26A, or the server 30, which executes a server program 32B1 with a server CPU 32A.

The short distance communication device 13 is configured to perform wireless communication with the printer 20 at a short distance. The short distance communication device 13 includes a communication circuit configured to perform the wireless communication with a short distance communication device 21 of the printer 20, which will be described later, using, for example, Bluetooth (a registered trademark of Bluetooth SIG, Inc.) or NFC (an abbreviation for Near Field Communication). The display 14 is used to display various types of information. The display 14 may be an LCD, organic EL display, or other types of display. As the input I/F 15, a touch panel integrated with the display 14 may be used to receive user operations on icons displayed on the display 14. The input I/F 15 may be a keyboard or a mouse.

The image obtaining device 16 includes, for example, a camera (not shown in the drawings) provided with the mobile terminal 10, and is configured to obtain image data representing images captured by the camera. The image obtaining device 16 may also be configured to obtain image data from an external device, such as a hard disk drive (HDD). The image data obtained by the image obtaining device 16 may be converted into print data 12C and stored in the terminal storage 12.

The external communication device 17 includes a communication circuit configured to transmit and receive data with the router 2 via wireless communication in accordance with, for example, the Wi-Fi (a registered trademark of Wi-Fi Alliance) communication standard. The external communication device 17 is connected to the printer 20 via the router 2. Further, the external communication device 17 is connected to the server 30 via the router 2 and the Internet 3. Alternatively, the external communication device 17 may be connected to the router 2 via a wired LAN cable or other wired communication.

### Configuration of Printer

The printer 20 is, for example, an inkjet color printer. The printer 20 includes the short distance communication device 21, an external communication device 22, an ink reservoir including one or more ink tanks 23, an ink level detector 24, a print engine 25, a user interface 27, and a printer controller 26. In certain embodiments, only one ink tank 23 is used for one color of ink (e.g., black ink). In other embodiments, multiple ink tanks 23 may be provided for storing, for example, different colors of ink, such as magenta (M), cyan (C), yellow (Y), and black (BK).

The external communication device 22 includes a communication circuit that is configured to transmit/receive signals to/from external devices (e.g., the mobile terminal 10 and the server 30 in the present embodiment) connected via a network. The ink tank 23 is a container for storing ink. In the present embodiment, four types of ink (i.e., magenta (M), cyan (C), yellow (Y), and black (BK)) are used, and multiple ink tanks 23 are provided for the respective types of ink. That is, in the present embodiment, the printer 20 uses four ink tanks 23 to store the four types of ink independently of each other. It should be noted that the ink reservoir may be configured as a single tank 23 with its interior divided into multiple compartments, each for storing different types (e.g., colors) of ink, instead of using multiple ink tanks 23.

Each ink tank 23 is provided with, for example, an inlet (not shown in the figures) and is configured to enable the user to fill the ink via the inlet. The ink level detector 24 is configured to detect the ink level, which represents the amount of ink remaining in the ink tank 23, as a percentage, for example, with 100% being full. The ink level detector 24 is arranged on the ink tank 23 and has an optical sensor that detects the height of the ink surface and detects the ink level based on the output from the optical sensor. It should be noted that, when there are multiple ink tanks 23, the ink level detector 24 is arranged on each of the multiple ink tanks 23 and detects the ink level in each of the multiple ink tanks 23.

The print engine 25 includes a print head, a carriage that mounts the print head, and a conveying mechanism that conveys sheets, and performs printing by ejecting ink stored in the ink tanks 23 from the print head onto the sheet. The print engine 25 performs a process of printing images such as ones represented by the print data 12C received from the mobile terminal 10 on the sheets using a known inkjet printing method. The user interface 27 is, for example, a touch panel integrated with the display, push button switches, and so on, and is configured to receive operation input by the user and display various types of information. The printer controller 26 is configured to perform overall control of the printer 20. The printer controller 26 includes the printer CPU 26A and a printer storage 26B.

It should be noted that the above-described configuration of the printer 20 is only an example. The printer controller 26 may be configured in such a manner that various processes are performed by only the printer CPU 26A, by an integrated circuit such as an ASIC, or by the printer CPU 26A and an ASIC working in cooperation with each other.

The printer CPU 26A is configured to control the operation of the printer 20 by executing a printer program 26B1 stored in the printer storage 26B. The printer CPU 26A may be a single-core CPU or a multi-core CPU. The printer program 26B1 is a program that manages the printer 20 integrally and performs various processes on the printer 20. The printer storage 26B includes, for example, a combination of a RAM, a ROM, a flash memory, an HDD, and a buffer provided to the printer CPU 26A.

The printer storage 26B stores a printer management table PT. The printer management table PT stores information about the printer 20 in relation to the use of the print service. The information stored in the printer management table PT is used as appropriate when various processes are performed. The printer management table PT stores device IDs, the printable face count, the ink level, device settings, and the date and time of synchronization, in an associated manner.

While the user is enrolling in the second print service, the number of printable faces, which is calculated by subtracting the printed face count from the predetermined number of faces, is stored. However, in consideration of the fact that the first print service could be switched back to the first print service via the second print service, if the number of printable faces is not zero even while the user is enrolling in the second print service, the number of printable faces for the first print service is also stored.

The device ID is, for example, a serial number set by the vendor of the printer 20, and is unique information that allows the printer 20 to be distinguished from other printers. The device ID is not limited to the serial number, but can be, for example, the MAC address of the external communication unit 22.

The number of printable faces indicates the number of faces on sheets that can be printed by the printer 20. The user of the printer 20 is allowed to print only on the number of faces specified by the number of printable faces stored in the printer management table PT. The print service provider charges the user a particular amount of money, and when the user pays the particular amount of money, the print service provider increases the number of printable faces in correspondence with the paid (i.e., charged) amount of money. As described above, the number of printable faces decreases as printing is performed by the printer 20.

The predetermined number of faces, like the number of printable faces, indicates the number of faces that can be printed by the printer 20 in the second print service. However, unlike the number of printable faces of the first print service, in the second print service, even if the predetermined number of faces decreases and reaches zero, the printer 20 is allowed to continue printing depending on the contract plan. Charges for exceeding the predetermined number of faces can be paid later. The number of printable faces and the predetermined number of faces may be stored in association with the user ID of the user using the printer 20.

The ink level indicates the amount of ink remaining as detected by the ink level detector 24. The printer 20 stores the ink level, which is detected by the ink level detector 24, in the printer management table PT after performing an operation that uses ink, such as refilling ink, checking nozzles, printing, and the like. The device settings are setting information for the functions of the printer 20 (printing and other functions), settings (i.e., sheet size, color, magnification, etc.) for respective functions, the language to be used for display on the user interface 27, and the like. The synchronization date and time are the date and time of the last (most recent) synchronization process with the server 30. The synchronization process here refers, for example, to the process of matching the number of printable faces or the remainder of the predetermined number of faces between the server 30 and the printer 20.

### Configuration of Server

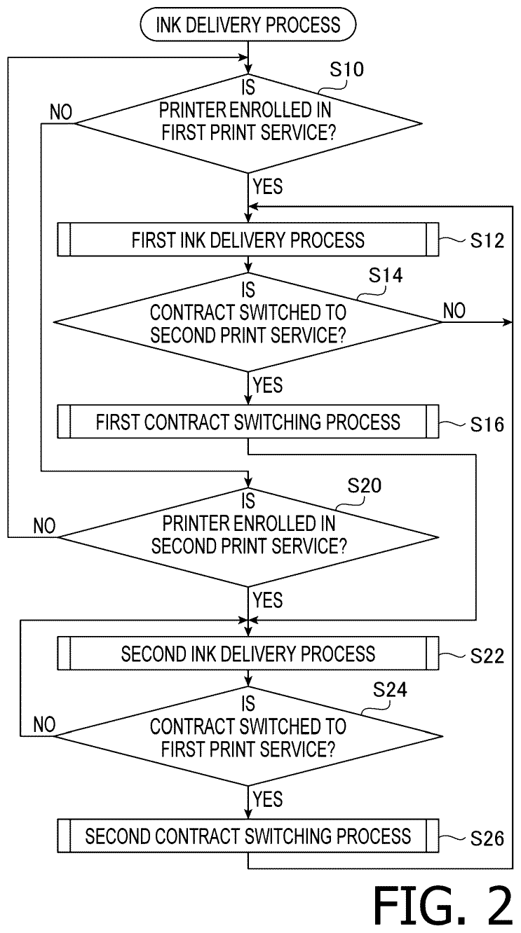

The server 30 includes an external communication device 31 and a server controller 32, as shown in FIG. 1. The external communication device 31 includes a communication circuit configured to perform communication with the mobile terminal 10 and the printer 20 to which the external communication device 31 is connected via a network. The server controller 32 is configured to integrally control the server 30. The server controller 32 includes a server CPU (which may be an example of a “controller” according to aspects of the present disclosure) 32A and a server storage 32B. The server CPU 32A controls the operation of the server 30 by executing the server program 32B1 stored in the server storage 32B. The server CPU 32A may be single-core or multi-core. The server program 32B1 is a program that integrally manages the server 30 and causes the server 30 to perform various processes. A program for a free ink utilization process, which will be described below referring to FIG. 2, is included in the server program 32B1.

The server storage 32B includes, for example, a combination of a RAM, a ROM, a flash memory, an HDD, and a buffer provided to the server CPU 32A. Further, in the server storage 32B, a server management table ST and contract information CI are stored. The server management table ST is a table that stores information necessary for using the print service. In the server management table ST, information on each of the printers 20 using the print service is stored in association with the device ID of the printer 20, and is managed by the print service provider. The information stored in the server management table ST is used as appropriate when various processes are executed.

In the server management table ST, the device ID, the number of printable faces (and the predetermined number of faces), the ink level, the print service enrollment status and the like are stored in an associated manner. The device ID, the number of printable faces, the predetermined number of faces, and the ink level in the server management table ST are the same as the corresponding data in the printer management table PT described above, and the data in the printer management table PT is stored in the server management table ST with the data in the printer management table PT associated with the corresponding device ID. It should be noted that the number of printable faces and the predetermined number of faces may be stored in association with the user ID of the user using the printer 20 instead of the device ID.

Furthermore, the server management table ST stores the delivery destination of ink bottles and ink cartridges, as well as the login ID, password, and e-mail address of the user of the mobile terminal 10 when the user logs into the server 30, for example, to apply for enrollment in or withdrawal from the print service. The print service enrollment status is information indicating whether or not the user of the printer 20 is enrolling in print services for the printer 20, as well as which print service the user is enrolling in. For example, when enrollment in the first print service is completed, the information indicates that the user is enrolling in the first print service; when enrollment in the second print service is completed, the information indicates that the user is enrolling in the second print service; and when withdrawal from the print service is completed, the information indicates that the user is not enrolling.

In the contract information CI, the contract information pertaining to the services provided by the print service provider is stored. Specifically, the contract information CI includes contract information pertaining to the first print service and contract information pertaining to the second print service. The contract information pertaining to the first print service and the contract information pertaining to the second print service each contain multiple pieces of contract information. The contract information includes, for example, the contract ID, the threshold for the ink level that serves as the criteria for delivery of consumables, the billing format for the contract's fee, and the contract period.

In the present embodiment, the server 30 manages the number of printable faces of each of a plurality of printers 20 using the print service by using the server management table ST, which associates the device ID with the number of printable faces. The server 30 manages the latest number of printable faces in the server management table ST by executing a synchronization process that synchronizes the contents of the printer management table PT and the server management table ST for the corresponding printer 20. The server 30 also manages the predetermined number of faces in the server management table ST, in the same manner as the number of printable faces.

Next, the print service provided to the user will be explained in detail, and then, the control processing performed by the print system 1 configured as described above will be explained with reference to flowcharts shown in FIGS. 2 to 5.

As described above, there are two print services: the first print service and the second print service. By selecting either the first or second print service and applying to the print service provider for enrollment, the user can enroll in the print service, and by applying for withdrawal, the user can withdraw from the print service. The user can also switch between the first and second print services to enroll. Here, the term “user” refers to a user who receives the print service, and is also a user of the printer 20. It should be noted that the user who receives the print service and the user of the printer 20 may be different, but in the present embodiment, the two are assumed to be the same.

If the ink remaining in the printer 20 is low while the user is enrolling in the print service, the print service provider will deliver ink bottles to the user free of charge, as described above. Concretely, when the user enrolls in the print service, the printer 20 reads the ink level stored in the printer management table PT at particular intervals (for example, every hour) and transmits the read ink level to the server 30. The server 30 stores the ink level transmitted from the printer 20 in the server management table ST, and also determines whether the ink level is below a particular threshold. If the ink level is below a particular threshold, the server 30 instructs a delivery service provider to deliver the ink bottle. Here, if the user is enrolling in the first print service, the particular threshold value is set to a, while if the user is enrolling in the second print service, the particular threshold value is set to β, which is greater than a.

The delivery service provider and the print service provider may be different or the same, but in the present embodiment, they are assumed to be the same. Furthermore, as described above, in the present embodiment, the printer 20 includes four types tanks 23, each configured to store one of the four types of ink, so the ink level is transmitted from the printer 20 to the server 30 for each type of ink and stored in the server management table ST. Therefore, the delivery of ink bottles is also done for each type of ink. As a method for the server 30 to obtain the ink level, in addition to the above method of receiving the ink level transmitted voluntarily by the printer 20, other methods may be used, such as a method in which the server 30 transmits a request to obtain the ink level to the printer 20 at particular intervals, and the server 30 receives and obtains the ink level transmitted by the printer 20 in response to this request. The timing at which the printer 20 transmits the ink level to the server 30 may be not only at particular intervals, but also after printing is executed or after the printer 20 is turned on, or at other predetermined times.

As described above, the user can switch the enrollment states between the first print service and the second print service. There is a quantitative relationship between the above-described threshold α for the first print service and the above-described threshold β for the second print service. Therefore, if the contract is switched from the first print service contract to the second print service contract, while the ink level of the printer 20 is greater than the threshold α when the user enrolled in the first print service, the ink level could become smaller than the threshold β when the user enrolled in the second print service. In such a case, the print service provider must immediately deliver the ink bottle(s) to the user.

Conversely, if the contract is switched from the first print service contract to the second print service contract, while the ink level is less than the threshold β when the user enrolled in the second print service, the ink level could become greater than the threshold α when the user enrolled in the first print service. In such a case, the print service provider needs to notify the user if the ink bottles have already been delivered, or stops delivery if the ink bottles have not been delivered.

As described above, if the user is allowed to switch between the enrollment status of the first print service and the second print service, a specific problem as mentioned above arises. The print system 1 according to the present embodiment is configured to address this problem.

FIG. 2 is a flowchart illustrating an ink delivery process performed in the server 30. The ink delivery process is started in response to turning on of the server 30, and terminates in response to the server 30 being powered off. In the following description of the flowcharts, “step” is denoted by the letter “S” and, for example, “step 1” is denoted as “S1.” In FIG. 2, the server 30 pauses until (S10: NO, and S20: NO) the printer 20 is enrolled in the first print service or the second print service. When the printer 20 is enrolled in the first print service (S10: YES), the control proceeds to S12, while when the printer 20 is enrolled in the second print service (S20: YES), the control proceeds to S22. To enroll the printer 20 in the print service, for example, the user may perform user registration to the server 30 through the mobile terminal 10, and then make the enrollment application described above from a user page (not shown) that is displayed after logging in the server 30. The server 30 is configured to store the login ID, the password, and the e-mail address of the user in the server management table ST in the server storage 32B when the user is registered. Further, when the server 30 receives an enrollment application from a logged-in user, the server 30 associates the device ID of the printer 20 with the login ID of the user and stores the same in the server management table ST, and updates the print service enrollment status stored in the server management table ST according to the print service for which the enrollment application was made. When updating the service enrollment status, the server 30 determines that the printer 20 has been enrolled in the print service (i.e., the user of the printer 20 enrolls in the print service).

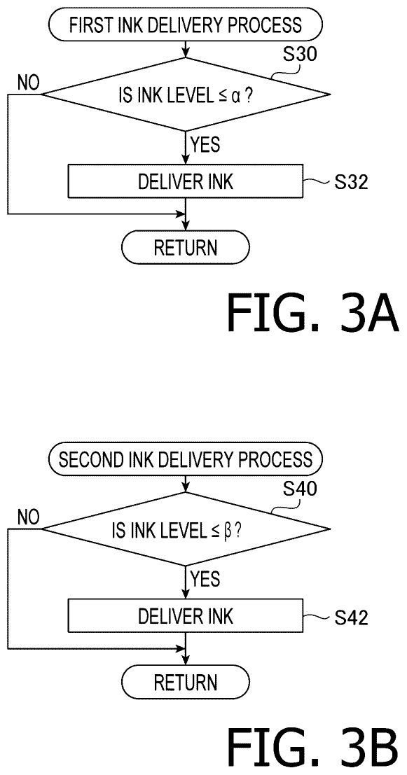

In S12, the server 30 executes a first ink delivery process. FIG. 3A shows a detailed procedure of the first ink delivery process. It is assumed that the server 30 has obtained the ink level of the printer 20 and stored the ink level in the server management table ST. The server 30 determines whether or not the ink level of the printer 20 stored in the server management table ST is equal to or less than the threshold α (S30). When the ink level is less than or equal to the threshold α (S30: YES), the server 30 performs a process of delivering a one ink bottle to the user (S32). The process of delivering an ink bottle includes, for example, a process of transmitting an instruction to deliver an ink bottle to a delivery center for ink bottles. After execution of S32, the server 30 stores information indicating that the ink bottle has been delivered in the server management table ST, in association with the device ID of the printer 20. Then, the server 30 terminates the first ink delivery process. On the other hand, when the server 30 determines that the ink level is greater than the threshold α (S30: NO), the server 30 skips S32 and terminates the first ink delivery process.

In S14 of FIG. 2, the server 30 determines whether a request has been made to switch from the contract for the currently enrolled first print service to the contract for the second print service. When the user submits a request to switch the print service contract via the user page (not shown), the server 30 determines that a switch from the first print service contract to the second print service contract has been requested. Thus, when the switching of the contract from the first print service contract to the second print service contract has not been performed, while the enrollment in the first print service is maintained (S14: NO), the server 30 returns the process to S12 and keeps executing the first ink delivery process S12. When the server 30 has determined that the change of the contract from the first print service to the second print service has been requested (S14: YES), the server 30 performs a first contract switching process in which the contact is changed from the first print service contract to the second print service contract (S16), and proceeds to S22.

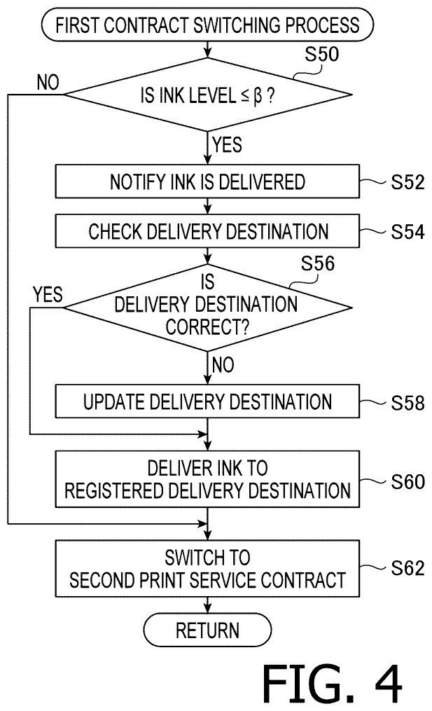

FIG. 4 is a flowchart illustrating the first contract switching process to switch the contract from the first print service contract to the second print service contract. When the first contract switching process is performed, the server 30 determines, in S50, whether or not the ink level is less than or equal to the threshold β which is the threshold defined for the second print service. It should be noted that the threshold α is smaller than the threshold β. Even if the ink level is greater than the threshold α when the user enrolls in the first print service, the ink level could be less than or equal to the threshold β for the second print service. Therefore, when the contract has been switched from the first print service contract to the second print service contract, it is necessary to determine initially whether or not the ink level is less than or equal to the threshold β.

When it is determined that the ink level is less than or equal to the threshold β (S50: YES), the server 30 notifies the mobile terminal 10 that the ink bottle is to be delivered (S52). When the user is enrolling in the first print service, the ink bottle is delivered whenever the ink level becomes less than or equal to the threshold α, the user may mistakenly think that handling of ink is the same as when the user is enrolling in the first service, even if the user is enrolling in the second print service. In such cases, the user will feel a sense of discomfort if the ink bottle is delivered without prior notice, and thus a notification is provided to avoid such a feeling of discomfort. A possible notification method would be, for example, a pop-up on the display 14 of the mobile terminal 10 that an ink bottle is being delivered, or an e-mail notification.

Following the notification in S52, the server 30 inquires the user whether the delivery destination is correct (S54). This inquiry includes an inquiry asking whether there have been any changes from the delivery destination registered in the first print service and, if the delivery destination is changed, the inquiry will include information that prompts the user to register the changed delivery destination. This inquiry may be made together with the notification in S52, or may be made independently. As for the inquiry method, a pop-up display, e-mail notification, or other methods are possible, as are the notification methods. When the user transmits a reply to the server 30, the server 30 determines whether the delivery destination is the same as the one registered for the first print service, i.e., whether the delivery destination to which the ink bottle is being delivered is correct (S56). If, in the determination, the reply contains information on a delivery destination different from the registered delivery destination, i.e., the delivery destination is not correct (S56: NO), the server 30 updates the registered delivery destination with the correct delivery destination (S58) and then performs the process to deliver the ink bottle to that delivery destination (S60). On the other hand, if the delivery destination is correct (S56: YES), the server 30 performs a process to deliver the ink bottle to the delivery destination that has already been registered (S60). Then, the server 30 stores information indicating that the ink bottle has been delivered in the server management table ST, in association with the device ID of the printer 20.

It should be noted that before executing the process for delivering the consumables in S60, the user may be notified of the delivery destination. In such a case, the delivery destination may be notified together with the notification in S52. In that case, the process in S52 may be moved to before the process in S60. Furthermore, if the printer 20 has a GPS function, for example, and the server 30 is configured to obtain the location of the printer 20, the server 30 may notify the user, either together with the delivery destination or independently. Further, in such a case, the server 30 may perform the determination in S56 based on the obtained location of the printer 20. Concretely, the server 30 stores the installation location of the printer 20 in the server management table ST in association with the type of the print service (in the present embodiment, either the first or second print service), and if the stored installation location and the obtained installation location are different, the server 30 makes a negative determination in S56 (S56: NO). In such a case, the inquiry in S54 need not be performed.

In S62, the server 30 changes the contract from one for the first print service to one for the second print service. The contract change can be done by rewriting an area in the server management table ST that stores the print service enrollment status to the second print service enrollment status. Thereafter, the server 30 terminates the first contract switching process.

If the ink level is greater than the threshold β (S50: NO), the server 30 skips S52-S60 and proceeds to S62 and changes the contract to one for the second print service, and then terminates the first contract switching process.

In S22 of FIG. 2, the server 30 performs the second ink delivery process. FIG. 3B is a flowchart illustrating the second ink delivery process in detail. In FIG. 3B, the server 30 determines whether or not the ink level of the printer 20 stored in the server management table ST is less than or equal to the threshold β (S40). When the ink level is less than or equal to the threshold β (S40: YES), after performing a process of delivering one ink bottle to the user (S42), the server 30 stores information indicating that one ink bottle has been delivered in the server management table ST in association with the device ID of the printer 20. Thereafter, the server 30 terminates the second ink delivery process. On the other hand, when the ink level is greater than the threshold β (S40: NO), the server 30 terminates the second ink delivery process, skipping S42.

In S24 of FIG. 2, the server 30 determines whether or not a request has been made to switch from the contract for the currently enrolled second print service to the first print service contract. If a request to switch to the first print service contract is not made and the second print service contract is still ongoing (S24: NO), the server 30 returns the process to S22 and continues the second ink delivery process in S22. On the other hand, if a request is made to switch to the first print service contract (S24: YES), the server 30 performs the second contract switching process (S26), and then proceeds to S12.

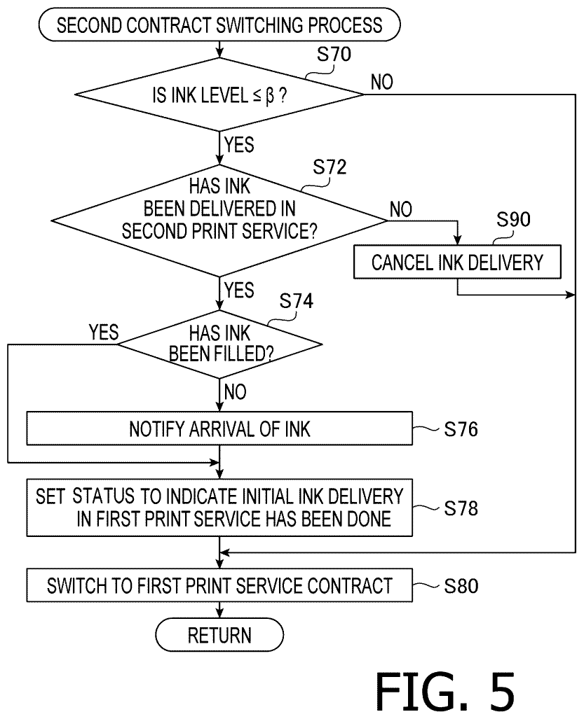

FIG. 5 shows the procedure for the second contract switching process, which is the process for switching from the second print service contract to the first print service contract. In FIG. 5, the server 30 determines whether the ink level is less than or equal to the threshold β for the second print service, in the same way as in S50 of FIG. 4 (S70). In this determination, if the ink level is less than or equal to the threshold β (S70: YES), the server 30 refers to the server management table ST to determine whether or not the ink bottle has already been shipped in the second print service (S72). If the ink bottle has already been shipped (S72: YES), the server 30 determines whether the ink in the ink bottle has been filled into the tank 23 (S74). This determination can be made by determining whether the ink level has increased or not. If the ink bottle has not already been filled with ink in the tank 23 (S74: NO), the server 30 notifies the mobile terminal 10 that the ink bottle will be delivered (S76). The notification method should be the same as the method described in S52 (FIG. 4) above. In S78, the server 30 sets the initial delivery status of the ink bottle after switching to the first print service contract to “delivered.”

On the other hand, if the ink of the ink bottle has already been filled in the tank 23 (S74: YES), the server 30 skips S76 and proceeds to S78, and sets the initial delivery status of the ink bottle after the contract is switched to the first delivery of the first print service to “delivered.”

Whether or not to perform the notification of S76 is determined by checking whether or not the ink of the ink bottle has been filled in the tank 23, but it is also possible to determine whether or not to perform the notification by checking the length of time that has elapsed since the ink bottle was shipped. That is, if a significant amount of time has passed (for example, if a month has passed since shipping), the ink bottle should have already been delivered to the user, so there is no need to notify the user that the ink bottle will be delivered.

In S80, the server 30 switches its contract to the first print service contract. After that, the server 30 terminates the second contract switching process.

On the other hand, if the ink bottle has not been shipped by the second print service (S72: NO), the server 30 cancels the delivery of the ink bottle (S90) and then proceeds to S80. In S80, the server 30 switches the contract to the first print service contract and terminates the second contract switching process after.

On the other hand, if the ink level is greater than threshold (S70: NO), the server 30 skips S72 to S78 and S90, and proceeds to S80. In S80, the server 30 switches the contract to the first print service contract and terminates the second contract switching process.

In the present embodiment, the server 30 is configured to transmit the notifications in S52 and S54 when the ink level is less than or equal to the threshold β, but the configuration is not limited to this. The notification may be sent immediately after the first contract switching process is started, i.e., when the particular information in the contract information of the first print service, the threshold α, differs from the particular information in the contract information of the second print service, the threshold β. In such a case, the notifications of S52 and S54 may be transmitted before S50 in FIG. 4. Even if the ink level is greater than the threshold β at the time when the contract is switched from the first print service contract to the second print service contract, if the delivery destination is confirmed in advance, the ink bottle can be delivered without checking the delivery destination when the ink level becomes less than or equal to the threshold β due to repeated printing.

In the present embodiment, when the contract is switched between the first print service contract and the second print service contract, which have different thresholds, the notification in S52 or S76 is performed. The configuration is not necessarily limited to the above, and even if the contract is switched between the first print service contract and the second print service contract, which have the same thresholds, if the location of the printer 20 stored in the server management table ST and the location of the printer 20 obtained from the GPS function of the printer 20 differ, the user may be notified to that effect. It should be noted that, in such a case, the notification content is not about the ink bottle being delivered, as the notification in S52 or S76, but about the fact that the location of the printer 20 has been changed. Such a notification could be, for example, a request for confirmation that the delivery destination of the ink bottle can be updated to the installation location of the switched printer 20. Such a notification may also be sent when the IP address of the printer 20 is switched.

As described above, the print system 1 according to the present embodiment is a print system configured to include the printer 20 that consumes the ink and the server CPU 32A. The server CPU 32A is configured to receive a request to switch the contract from the first print service to the second print service that is different from the first print service (S14). The server CPU 32A also performs the notification process (S52, S54) to send the notification to the user of the printer 20 in response to the fact that the particular information contained in the information on the contract for the first print service differs from the particular information contained in the information on the contract for the second print service (S14: YES).

As described above, since the server CPU 32A also performs the notification process (S52, S54) to send the notification to the user of the printer 20 in response to the fact that the particular information contained in the contract information regarding the first print service differs from the particular information contained in the contract information regarding the second print service (S14: YES), it becomes possible to notify the user appropriately when conditions of the contract are switched.

The particular information includes thresholds α and β regarding the ink level remaining in the printer 20. In this way, it is possible to deal with problems that may arise due to switching between thresholds α and β for the ink level by appropriately notifying the user in advance.

The contract information for the first print service includes the threshold α and the contract information for the second print service includes the threshold β. In response to the threshold α and the threshold β being different (S14: YES), the server CPU 32A executes the notification process (S52, S54). In this way, it is possible to deal with problems that may arise due to switching between thresholds α and β for the ink level by appropriately notifying the user in advance.

In response to the fact that the contract of the print service has been changed from the first print service to the second print service, in other words, in response to the threshold (i.e., the threshold β) of the second print service after the print service has been switched being greater than the threshold (i.e., the threshold α) before the print service has been switched (S14: YES), the server CPU 32A executes the notification processing (S52, S54). In this way, it is possible to deal with problems that arise due to switching between thresholds α and β for the ink level by appropriately notifying the user in advance.

In response to the contract of the print service being switched from the first print service to the second print service, in other words, when the threshold (the threshold β) of the second print service after the change is greater than the threshold (the threshold α) of the first print service before the switch (S14: YES), and the remaining amount of the consumables of the printer 20 is less than or equal to the threshold β (S50: YES), the server CPU 32A executes the notification process (S52 and S54). In this way, it is possible to deal with problems that arise due to switching between thresholds α and β for the ink level by appropriately notifying the user in advance.

The server CPU 32A does not transmit a notification (S52, S54) when the print service has not been switched from the second print service to the first print service, in other words, when the threshold (the threshold α) of the first print service after the switch is smaller than the threshold (the threshold β) of the second print service before the switch (S20: YES). In this way, it is possible that the server CPU 32A can avoid sending unnecessary notifications.

When the print service is switched from the second print service to the first print service, that is, when the threshold value (the threshold α) of the first print service after the switch is smaller than the threshold value (the threshold β) of the second print service before the switch (S20: YES), and when ink has already been shipped based on the threshold value (the threshold β) of the second print service before the switch (S72: YES), the server CPU 32A notifies the user that the ink will arrive (S76). In this way, the user can know that the ink will arrive.

In the notification process, the server CPU 32A notifies the information used to confirm the destination of the ink delivery (S54). This allows the ink to be delivered to the correct destination.

The server CPU 32A executes an obtaining process to obtain information on at least one of the location of the printer 20 and the destination where the ink is to be delivered, and in the notification process, the server CPU 32A notifies the information obtained in the obtaining process to the user (S52). In this way, the user can obtain the information on the location of the printer 20 and/or the destination where the ink is to be delivered (i.e., the information on one or both of the location of the printer 20 and the destination where the ink is to be delivered).

The contract information includes location information indicating the position of the printer 20. The server CPU 32A executes a current location information obtaining process to obtain current location information indicating the current location of the printer 20 from the printer 20. The server CPU 32A notifies the user in accordance with the following conditions: particular information in the contract information for the first print service does not differ from particular information in the contract information for the second print service, and the location information contained in the first contract information differs from the location information obtained in the location information obtaining process. In this way, even if the terms of the contract are not changed, it is possible to provide the user with appropriate notification if the location information contained in the first contract information differs from the location information obtained in the location information obtaining process. It is noted that the particular information in the contract information for the first print service includes the threshold α, and the particular information in the contract information for the second print service includes the threshold β.

As described above, the server 30 according to the present embodiment is a server configured to manage the printer 20, which consumes ink, and includes the server CPU 32A. In response to the server CPU 32A receiving a request for switching the print service from the first print service to the second print service that is different from the first print service (S14), and the ink level contained in the first contract information and the ink level contained in the contract information for the second print service being different (S14: YES), the server CPU 32A performs the notification process (S52 and S54) to send a notification to the user of the printer 20.

Since the server 30 according to the present embodiment is configured in such a manner that the server is configured to receive a request for switching the print service from the first print service to the second print service that is different from the first print service, and the server 30 is configured to perform the notification process to send a notification to the user of the printer 20 in response to the ink level contained in the first contract information and the ink level contained in the contract information for the second print service being different, the server 30 can send an appropriate notification to the user when the terms of contact is switched.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(1) In the above-described embodiment, as an example of a consuming device, the printer 20, which is an inkjet color printer, is employed. According to aspects of the present disclosure, a monochromatic printer may be employed instead of the color printer. Further, instead of the inkjet color printer, an electrophotographic color or monochromatic printer may be employed. When the electrophotographic printer is employed, a toner cartridge may be an example of the consumables. The consumables do not have to be limited to ink and toner, but may also include various elements such as various rollers, print heads, photoreceptors, fixing devices, and the like. In such cases, the print service will deliver such consumables in accordance with the contract. In addition, as consuming devices, ones which are not included in the category of the image forming device, such as sewing machines, kerosene heaters, and the like may be included. In such cases, consumables may include, for example, sewing machine thread and kerosene.

(2) In the above-described embodiment, the server 30 is described as a single device. However, multiple servers may operate in an associated manner to perform the processing of the server 30 according to the above-described embodiment.

(3) In the above-described embodiment, the threshold of the ink level is given as an example of the particular information related to the contract. However, even if the consuming device is an image forming device, the threshold may be the life of the print head, photoconductor, or fixing device, not just the remaining ink or toner, and for devices that are not included in the category of image forming devices, such as the sewing machines or kerosene heaters, the threshold may be the remaining thread in the sewing machine or the remaining kerosene, or the life of various parts thereof.

(4) In the above-described embodiment, an example is given of a case where, when the switch of the print service from the first print service to the second print service is received (S14: YES), the notification process (S52 and S54) is executed, while when the switch of the print service from the second print service to the first print service is received (S20: YES), the notification process (S52 and S54) is not executed. However, the configuration is not necessarily limited to the above, and the notification process may be executed when the print service is switched from the second print service to the first print service. In such a case, a notification process similar to that of S52 and S54 may be executed before S70, before S80, or after S80. In other words, a notification process may be executed when the particular information contained in the contract information for the print service before the switch differs from the particular information contained in the contract information for the print service after the switch.

What is claimed is:

1. A consumable management system comprising a consuming device configured to consume a consumable and a controller,
wherein the controller is configured to:
receive a request to switch from a first contract to a second contract different from the first contract, the first contract being a contract for delivering the consumable of the consuming device; and
transmit a notification to a user of the consuming device in response to particular information in first contract information on the first contract being different from particular information in second contract information on the second contract.

2. The consumable management system according to claim 1,
wherein the particular information includes a threshold of a remaining amount of the consumable.

3. The consumable management system according to claim 2,
wherein the first contract information includes a first threshold as the threshold,
wherein the second contract information includes a second threshold as the threshold, and
wherein the controller is configured to transmit the notification to the user in response to the first threshold being different from the second threshold.

4. The consumable management system according to claim 3,
wherein the controller is configured to transmit the notification to the user in response to the second threshold being greater than the first threshold.

5. The consumable management system according to claim 3,
wherein the controller is configured to transmit the notification to the user in response to the second threshold being greater than the first threshold and the remaining amount of the consumable being equal to or less than the second threshold.

6. The consumable management system according to claim 3,
wherein the controller is configured not to transmit the notification to the user in response to the second threshold being smaller than the first threshold.

7. The consumable management system according to claim 3,
wherein the controller is configured to notify that the consumable will arrive in a case where the second threshold is smaller than the first threshold and the consumable has been delivered based on the first threshold.

8. The consumable management system according to claim 1,
wherein the controller is configured to notify information used to confirm a destination of the consumable when transmitting the notification.

9. The consumable management system according to claim 1,
wherein the controller is configured to obtain information on a location of the consuming device and/or a destination where the consumable is to be delivered, and
wherein the controller is configured to notify the obtained information when transmitting the notification.

10. The consumable management system according to claim 1,
wherein the first contract information includes location information on a location of the consuming device,
wherein the controller is configured to:
obtain current location information indicating a current location of the consuming device; and
transmit the notification in response to the particular information in the first contract information being different from the particular information in the second contract information, and the location information included in the first contract information being different from the current location information.

11. A consumable management apparatus configured to manage a consuming device configured to consume a consumable, the consumable management apparatus comprising a controller,
wherein the controller is configured to:
receive a request to switch from a first contract to a second contract different from the first contract, the first contract being a contract for delivering the consumable of the consuming device; and
transmit a notification to a user of the consuming device in response to particular information in first contract information on the first contract being different from particular information in second contract information on the second contract.
